(19) United States
(12) Patent Application Publication
(10) Pub. No.: US 2006/0020441 A1
(43) Pub. Date: Jan. 26, 2006

(54) Method and system for creating timing constraint library

(75) Inventors: Toru Toyoda, Kanagawa (JP); Tamami Shimizu, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/185,748

(22) Filed: Jul. 21, 2005

(30) Foreign Application Priority Data
Jul. 22, 2004 (JP) 2004/214134

(51) Int. Cl. G06F 17/50

(52) U.S. Cl. 703/19

(57) ABSTRACT

A cell has input pins and output pins, and the input pins are connected to output pins through timing arcs. A method of creating a timing constraint library of the cell includes: selecting one of the timing arcs as a representative timing arc; calculating the timing constraint with respect to the representative timing arc by simulating the cell under all of a fundamental condition group; extracting partial conditions from the fundamental condition group; and calculating the timing constraint with respect to another of the timing arcs which shares any of the input pin and the output pin with the representative timing arc by simulating the cell under the extracted partial conditions.

### BACKGROUND OF THE INVENTION

1. Field of the Invention

The present invention relates to a technique of LSI designing. In particular, the present invention relates to a system and a method for creating a timing constraint library which provides timing constraint of a cell.

2. Description of the Related Art

In a process of designing an LSI, to utilize a computer and a CAD (Computer Aided Design) is indispensable in order to reduce designing time and checking time and to avoid artificial mistakes. In the field of the LSI designing, a technique of utilizing a “cell”, which is a functional block having a specific function, for the purpose of further improving development efficiency is publicly known. According to a cell-base design which utilizes the cell, a desired LSI is designed by combining and arranging a plurality kinds of cells. As a result, the designing time is shortened and productivity is improved.

An information which indicates a constraint for a normal operation of such a cell is called a “timing constraint (timing constraint information)”. For example, the timing constraint is a delay time from an input pin to an output pin of the cell. Also, the timing constraint can include a setup time and a hold time of a data signal with respect to a clock signal. Such the timing constraint information is distributed together with circuit information of the designed/verified cell.

After an LSI is designed on the basis of the cell-base design, a “timing analysis” is performed in which an operation of the designed LSI is analyzed and verified. In order to carry out the timing analysis for an LSI including a plurality of cells, it is necessary to obtain information about interconnections between the plurality of cells and the above-mentioned timing constraint information with respect to each of the plurality of cells. For that purpose, a “timing constraint library” which provides the timing constraint information of respective cells is prepared, and then the above-mentioned timing analysis is performed by referring to the timing constraint library.

The timing constraint library includes a “timing constraint table” which is an array indicating the timing constraints with regard to a plurality of conditions. In a case of a timing constraint table indicative of the delay times, for example, the plurality of conditions are given by combinations of a plurality of first indices (input waveform roundings at an input pin) and a plurality of second indices (load capacitances at an output pin). Such a timing constraint table is disclosed in Japanese Laid Open Patent Application JP-H10-269275. Also, a conventional technique of creating such a timing constraint table is disclosed in Japanese Laid Open Patent Application JP-P2004-139360.

The information amount of the timing constraint library is vast, and it is preferable to reduce the time required for creating the timing constraint library. Therefore, it is strongly desired to create the timing constraint table for each cell more efficiently.

### SUMMARY OF THE INVENTION

In a first aspect of the present invention, a method of creating a timing constraint library which provides “timing constraint” of a cell is provided. The cell has at least one input pin and at least one output pin. Each of the at least one input pin is connected to each of the at least one output pin through a corresponding one of a plurality of timing arcs.

The method includes the steps of: (A) providing a memory device which stores circuit data of the cell; (B) a processor selecting one of the plurality of timing arcs as a representative timing arc by referring to the circuit data stored in the memory device; (C) the processor calculating the timing constraint with respect to the representative timing arc by simulating the cell under all conditions of a predetermined fundamental condition group; (D) the processor extracting partial conditions from the predetermined fundamental condition group, namely, the processor degenerating the predetermined fundamental condition group; and (E) the processor calculating the timing constraint with respect to another of the plurality of timing arcs which shares any of the input pin and the output pin with the representative timing arc by simulating the cell under the extracted partial conditions.

In a second aspect of the present invention, the cell has M input pins (M is a natural number) and N output pins (N is a natural number). Timing arcs connecting between the M input pins and the N output pins are denoted by an MN matrix P_{MN}. In this case, the method includes the steps of: (AA) a processor calculating the timing constraint with respect to a timing arc Pᵢᵢ (i is a natural number not less than 1 and not more than M and N) by simulating the cell under all conditions of a predetermined fundamental condition group; (BB) the processor generating a first degenerate condition group by degenerating the predetermined fundamental condition group based on a result of the step (AA), and storing the generated first degenerate condition group in a memory device; (CC) the processor calculating the timing constraint with respect to another timing arc Pⱼⱼ (j is a natural number not less than 1 and not more than M and N) by simulating the cell under all conditions of the predetermined fundamental condition group; (DD) the processor generating a second degenerate condition group by degenerating the predetermined fundamental condition group based on a result of the step (CC), and storing the generated second degenerate condition group in the memory device; and (EE) the processor calculating the timing constraint with respect to timing arcs Pᵢⱼ and Pⱼᵢ by simulating the cell under the first degenerate condition group and the second degenerate condition group stored in the memory device.

In a third aspect of the present invention, the cell has a plurality of input pins and a clock pin to which a clock signal is input. In this case, the method includes the steps of (a) providing a memory device which stores circuit data of the cell; (b) a processor selecting one of the plurality of input pins as a representative pin by referring to the circuit data stored in the memory device; (c) the processor calculating the timing constraint of an input signal input to the representative pin with respect to the clock signal by simulating the cell under all conditions of a predetermined fundamental condition group; (d) the processor extracting partial conditions from the predetermined fundamental condition group, namely, the processor degenerating the predetermined fundamental condition group; and (e) the processor calculating the timing constraint of an input signal input to another of the plurality of input pins with respect to the clock signal by simulating the cell under the extracted partial conditions.

In a fourth aspect of the present invention, a system for creating the timing constraint library is provided. The system includes: the memory device configured to store the circuit data of the cell; the processor configured to access the memory device; and software executed by the processor. The processor operates according to instructions by the software to perform the above-mentioned method.

According to the method and the system for creating the timing constraint library in the present invention, the time required for creating the timing constraint library can be reduced. The reason is that a degenerate timing constraint table is generated from a timing constraint table obtained with respect to the representative timing arc, and then another degenerate timing constraint table with respect to another timing arc is obtained by utilizing the foregoing degenerate timing constraint table.

### BRIEF DESCRIPTION OF THE DRAWINGS

The above and other objects, advantages and features of the present invention will be more apparent from the following description taken in conjunction with the accompanying drawings, in which:

FIG. 1 is a conceptual diagram showing a configuration of a timing constraint library according to an embodiment of the present invention;

FIG. 2 is a schematic diagram showing a configuration of a cell according to the embodiment of the present invention;

FIG. 3 is a conceptual diagram showing a configuration of a constraint table group according to the embodiment of the present invention;

FIG. 4 is a conceptual diagram showing a delay time table with respect to a timing arc according to a first embodiment of the present invention;

FIG. 5 is a conceptual diagram showing a fundamental condition table according to the first embodiment of the present invention;

FIG. 6 is a graph for explaining a degeneration process performed in the first embodiment of the present invention;

FIG. 7 is a conceptual diagram showing a configuration of a delay time table group which is created in the first embodiment of the present invention;

FIG. 8 is a block diagram showing a configuration of a timing constraint library creating system according to the first embodiment of the present invention;

FIG. 9 is a block diagram showing an operation of the timing constraint library creating system according to the first embodiment of the present invention;

FIG. 10 is a flowchart showing a method of creating the timing constraint library according to the first embodiment of the present invention;

FIG. 11 is a conceptual diagram showing an output waveform rounding table with respect to a timing arc according to a second embodiment of the present invention;

FIG. 12 is a schematic diagram showing a configuration of a cell according to an embodiment of the present invention;

FIG. 13 is a conceptual diagram showing a setup time table with respect to an input pin according to a third embodiment of the present invention;

FIG. 14 is a flowchart showing a method of creating the timing constraint library according to the third embodiment of the present invention; and

FIG. 15 is a conceptual diagram showing a hold time table with respect to an input pin according to a fourth embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

First, concepts and terms used in the present specification will be explained.

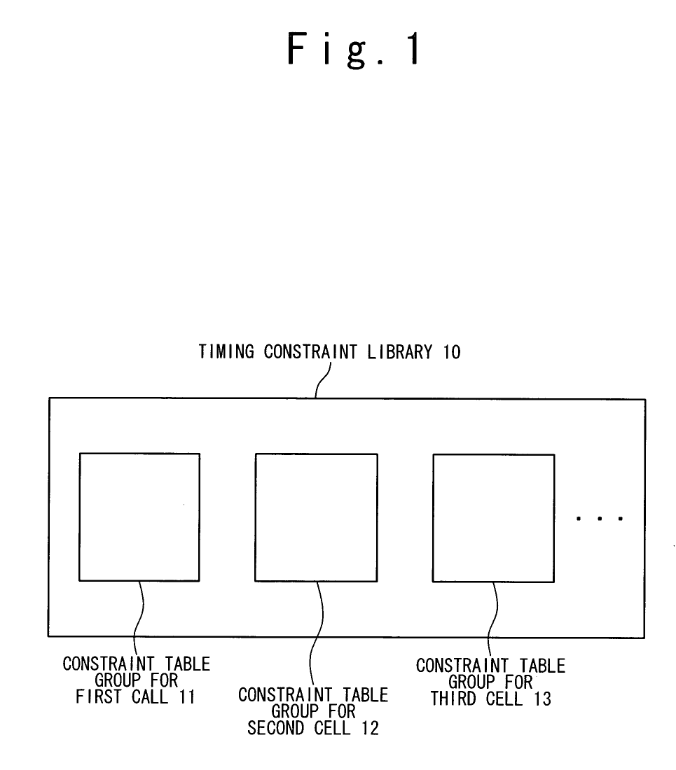

FIG. 1 is a conceptual diagram showing a configuration of a “timing constraint library” which is a target to be created in the present invention. The timing constraint library 10 provides “timing constraint (timing constraint information)” with respect to a plurality kinds of cells. More specifically, the timing constraint library 10 includes a plurality of timing constraint table groups such as a constraint table group 11 for a first cell, a constraint table group 12 for a second cell, a constraint table group 13 for a third cell and the like. Each timing constraint table group provides the timing constraint with regard to the corresponding cell. The timing constraint of each cell thus provided by the timing constraint library 10 is used in a timing analysis of an LSI.

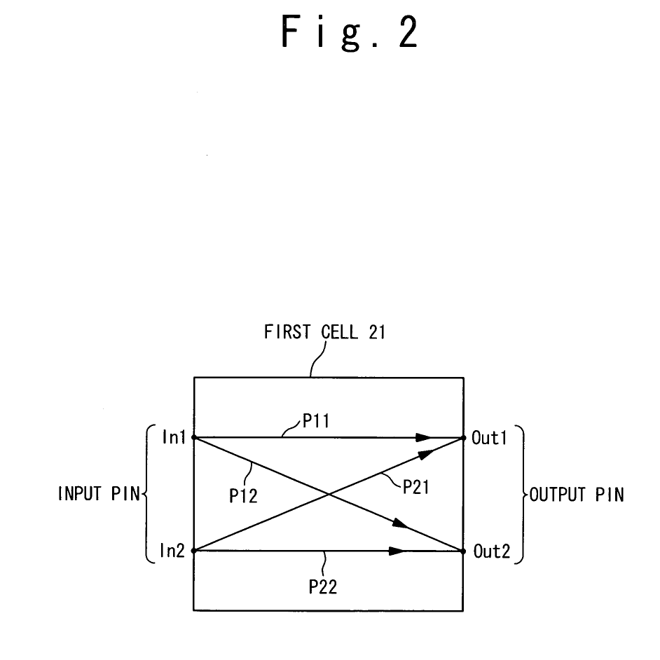

FIG. 2 is a schematic diagram showing a configuration of a cell in the embodiment of the present invention. The cell has at least one input pin and at least one output pin. For example, the first cell 21 shown in FIG. 2 as an example has input pins In1, In2 and output pins Out1 and Out2. Here, a path which connects between one of the input pins and one of the output pins is called a “timing arc”. The input pin In1 and the output pin Out1 are connected through a timing arc P11, and the input pin In1 and the output pin Out2 are connected through a timing arc P12. Similarly, the input pin In2 and the output pin Out1 are connected through a timing arc P21, and the input pin In2 and the output pin Out2 are connected through a timing arc P22. To speak in generalized terms, the cell has M input pins In (M is a natural number) and N output pins Out (N is a natural number). In this case, the timing arcs which connect between the M input pins In and the N output pins Out are denoted by an MN matrix P_{MN}.

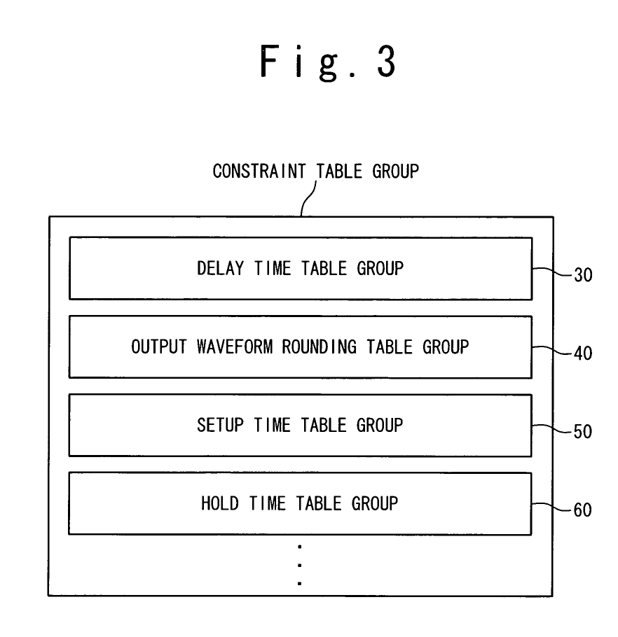

FIG. 3 is a conceptual diagram showing a configuration of a certain constraint table group for a certain cell shown in FIG. 1. As shown in FIG. 3, the constraint table group includes a delay time table group 30, an output waveform rounding table group 40, a setup time table group 50, a hold time table group 60 and the like. Each table group includes a plurality of “timing constraint tables”.

That is to say, the delay time table group 30 includes a plurality of “delay time tables” as the above-mentioned timing constraint tables. The plurality of delay time tables indicate delay times of signals for respective of the plurality of timing arcs P_{MN}.

The output waveform rounding table group 40 includes a plurality of “output waveform rounding tables” as the above-mentioned timing constraint tables. The plurality of output waveform rounding tables indicate “output waveform roundings” for respective of the plurality of timing arcs P_{MN}. Here, the output waveform rounding (output slope) is a degree of rounding of a signal at an output pin Out.

The setup time table group 50 includes a plurality of “setup time tables” as the above-mentioned timing constraint tables. The plurality of setup time tables indicate setup times with respect to a clock signal CLK of input signals DATA input to respective of the plurality of input pins In. In order to get the cell to operate properly, it is necessary to start an input of the input signal DATA at least a certain time before a latch operation, i.e., an input of the clock signal. The “setup time” is the certain time (limit value) with respect to the inputting of the input signal.

The hold time table group 60 includes a plurality of “hold time tables” as the above-mentioned timing constraint tables. The plurality of hold time tables indicate hold times with respect to the clock signal CLK of input signals DATA input to respective of the plurality of input pins In. In order to get the cell to operate properly, it is necessary to hold the input signal DATA at least a certain time after a latch operation, i.e., an input of the clock signal. The “hold time” is the certain time (limit value) with respect to the holding of the input signal.

As described above, the “timing constraints” include the delay time from the input pin In to the output pin Out, the output waveform rounding at the output pin Out, the setup time, the hold time and the like. A method of creating the table groups (30, 40, 50 and 60) regarding each of the timing constraints, namely, a method of creating the timing constraint library 10 will be described below in detail.

### First Embodiment

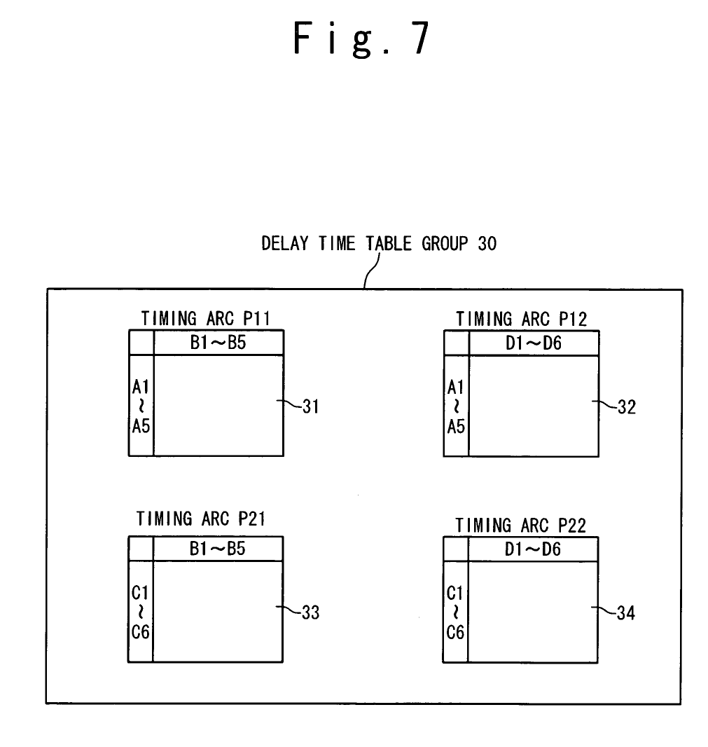

In a first embodiment of the present invention, the timing constraint is the “delay time” from the input pin In to the output pin Out, and a method of creating the “delay time table group 30” representing the delay time (refer to FIG. 3) will be described. The delay time table group 30 includes a plurality of delay time tables (timing constraint tables), respective of which are prepared with respect to the plurality of timing arcs P_{MN}. In a case of the first cell 21 shown in FIG. 2, for example, the delay time table group 30 includes four delay time tables (will be shown in FIG. 7) which are prepared for the timing arcs P11, P12, P21 and P22, respectively.

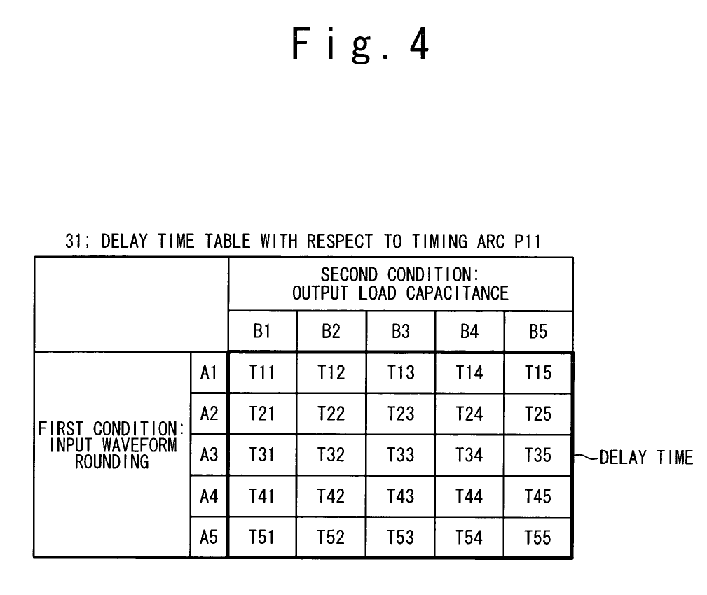

FIG. 4 is a conceptual diagram showing contents of a delay time table 31 which is created with respect to the timing arc P11. The delay time table 31 is a two-dimensional array indicating the delay times with respect to a plurality of conditions. The plurality of conditions are given by combinations of a plurality of first conditions and a plurality of second conditions. In the present embodiment, the first condition (first table index) is an “input waveform rounding (input slope)” which is a degree of waveform rounding of a signal input to the input pin In, and the second condition (second table index) is an “output load capacitance” which is a load capacitance applied to the output pin Out. For example, the plurality of conditions are given by combinations of the first conditions A1 to A5 and the second conditions B1 to B5 in FIG. 4. The delay time table 31 represents 25 kinds of delay times T11 to T55 for respective combinations.

The method of creating the delay time table group 30 including such the delay time table (31, 32, 33 and 34) is as follows.

First, one pin (a representative pin) is arbitrarily selected from the plurality of input pins In or the plurality of output pins Out. For example, let us suppose a case where the input pin In1 is selected as the representative pin from the plurality of input pins In. Connected to the representative pin In1 are the timing arcs P11 and P12. Next, one timing arc is selected as a “representative timing arc” from the plurality of timing arcs P11, P12. For example, let us suppose a case where the timing arc P11 is selected as the representative timing arc. It should be noted that the representative timing arc can be randomly selected from the plurality of timing arcs P11, P12, P21 and P22. Or, a timing arc having minimum stages of transistors may be selected as the representative timing arc out of the plurality of timing arcs P11, P12, P21 and P22.

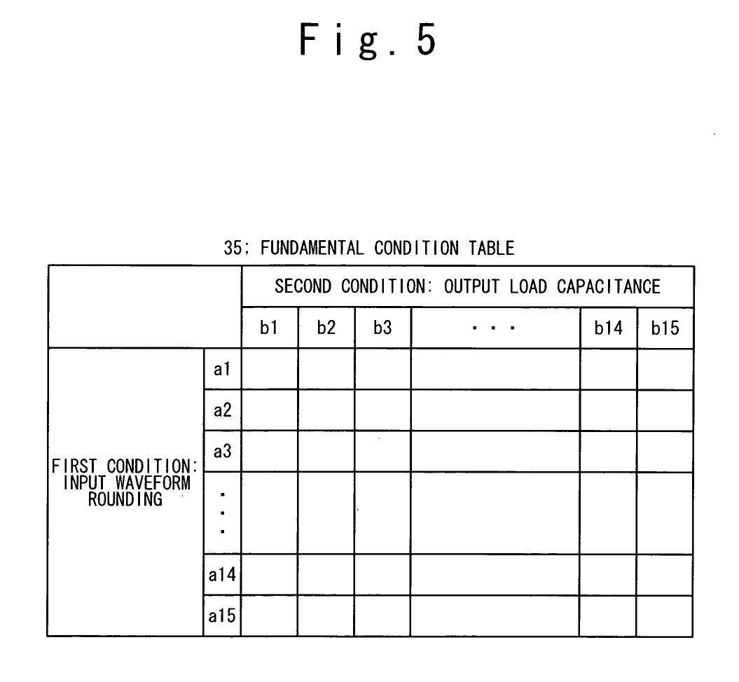

Next, the delay time table 31 with respect to the selected representative timing arc P11 is created (see FIG. 4). In order to create the delay time table 31, delay times under a great number of conditions are first measured. Here, the “great number” means a number enough to cover various conditions when the cell actually operates. In order to measure the delay times under the great number of conditions, a “fundamental condition table 35” shown in FIG. 5 is prepared. The fundamental condition table 35 is a two-dimensional array indicating combinations of a great number of the first conditions (input waveform roundings) and a great number of the second conditions (output load capacitances). For example, the fundamental condition table 35 represents 225 combinations of 15 kinds of first conditions a1 to a15 and 15 kinds of second conditions b1 to b15 in FIG. 5. The conditions of the 225 kinds given by the fundamental condition table 35 are hereinafter referred to as a “fundamental condition group”. The delay time for each condition in the fundamental condition group is obtained by executing a simulation with a simulation tool to which a parameter indicative of the each condition is applied. With regard to the foregoing representative timing arc P11, the delay times are calculated for all (225 kinds) of the conditions in the fundamental condition group according to the present embodiment. The table thus created is a “preliminary” delay time table 31.

When providing a final delay time table 31 with respect to the timing arc P11, it is not always necessary to provide the delay times for all the conditions in the fundamental condition group. It is better to make a size of the delay time table 31 to be provided for use in the timing analysis as small as possible. The reason is that a processing time in the timing analysis is reduced and also capacity of a memory device is saved. While it is necessary for the delay time table 31 to provide the delay times with respect to the timing arc P11 with a sufficient precision. Therefore, a certain number of conditions and delay times which are necessary and enough to represent the delay times with respect to the timing arc P11 are provided as the final delay time table 31. More specifically, optimum conditions are extracted from the foregoing fundamental condition group, based on the 225 kinds of delay times obtained as mentioned above. Such a process is referred to as “degeneration”, and the extracted optimum conditions are referred to as “partial conditions”.

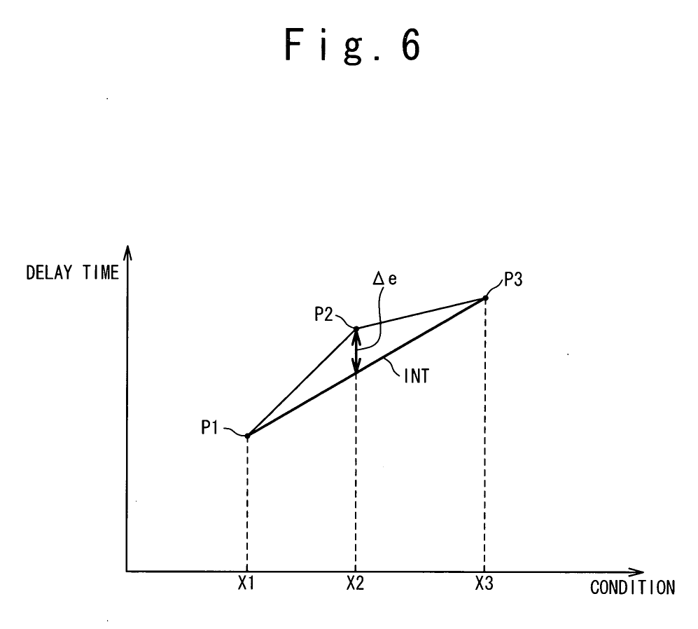

FIG. 6 is a graph for explaining an example of the “degeneration process” in the present embodiment. Here, let us suppose a situation that the delay times of the 225 kinds are already obtained with respect to the representative timing arc P11 and that all elements of the fundamental condition table 35 are determined. In this case, a certain first condition is first fixed, and then 15 kinds of fundamental conditions which are the second conditions corresponding to the fixed first condition are selected. Next, the 15 delay times obtained for the selected 15 fundamental conditions are considered and analyzed. Shown in FIG. 6 are three conditions X1, X2 and X3 among the 15 kinds of fundamental conditions and three points P1, P2 and p3 indicating the delay times obtained for respective of the three conditions X1, X2 and X3.

In FIG. 6, a line connecting between the point P1 and the point P3 through the point P2 indicates a function which represents a relation between the conditions and the delay times. In this case, it is judged whether or not the function can be approximated by a line INT interpolating between the point P1 and the point P3. In other words, it is judged whether or not the point P2 corresponding to the condition X2 located between the conditions X1 and X3 can be approximately obtained by interpolating between the point P1 and the point P3. More specifically, it is judged whether a distance Δe between the point P2 and the line INT as shown in FIG. 6 is within a predetermined error range or not. If the distance Δe is within the predetermined error range, the point P2 (the condition X2) is eliminated. If the distance Δe is equal to or larger than the predetermined error range, the point P2 is retained. In this manner, a minimum necessary number of the conditions are extracted from the above-mentioned 15 kinds of conditions.

Similarly, respective of the other first conditions are fixed, and the similar processes are carried out. Also, respective of the second conditions are fixed, and the similar processes are carried out. In this manner, optimum partial conditions are extracted from the fundamental condition group, i.e. the “degeneration process” is completed. As a result of the degeneration process, for example, the first conditions a1 to a15 in the fundamental condition group are reduced to the first conditions A1 to A5, and the second conditions b1 to b15 in the fundamental condition group are reduced to the second conditions B1 to B5 (see FIGS. 4 and 5). In other words, the partial conditions extracted from the fundamental condition group are constituted of combinations of the first conditions A1 to A5 and the second conditions B1 to B5. In this case, a function representing a relation between all the conditions in the fundamental condition group and the delay times is approximated within the predetermined error range by a function representing a relation between the partial conditions and the delay times. The delay times under the “partial conditions” are provided as the delay time table 31 shown in FIG. 4, which is used in the timing analysis. The delay time table 31 provides the delay times for the representative timing arc P11 with an excellent precision with the minimum necessary number of the elements.

Next, the delay time tables (32, 33 and 34) with respect to the other timing arcs P12, P21 and P22 other than the representative timing arc P11 are created. Here, the property of the cell with regard to the input waveform rounding depends on the input pin In. There is only a little difference in the property with regard to the input waveform rounding (first condition) between the plurality of timing arcs connected to the same input pin In. It is therefore preferable that the delay time table (32) with respect to the timing arc P12 which shares the input pin In1 with the representative timing arc P11 has the same first conditions A1 to A5 as the delay time table 31 with respect to the representative timing arc P11. As for the timing arc P12, in the present embodiment, the delay times are calculated on the basis of the foregoing partial conditions instead of the fundamental condition group.

Similarly, the property of the cell with regard to the output load capacitance depends on the output pin Out. There is only a little difference in the property with regard to the output load capacitance (second condition) between the plurality of timing arcs connected to the same output pin Out. It is therefore preferable that the delay time table (33) with respect to the timing arc P21 which shares the output pin Out1 with the representative timing arc P11 has the same second conditions B1 to B5 as the delay time table 31 with respect to the representative timing arc P11. As for the timing arc P21, in the present embodiment, the delay times are calculated on the basis of the foregoing partial conditions instead of the fundamental condition group.

According to the present embodiment as described above, with regard to the representative timing arc P11, the delay times are calculated for all (225 kinds) of the conditions in the fundamental condition group by referring to the fundamental condition table 35. On the other hand, with regard to the timing arc sharing a pin with the representative timing arc P11, the delay times are calculated only for the partial conditions (referred to as “degenerate conditions”). As a result, the number of simulations is reduced as compared with the conventional technique. Therefore, the time required for creating the delay time table group 30 is reduced, and hence the time required for creating the timing constraint library 10 is reduced.

FIG. 7 is a diagram for explaining an example of creating the delay time table group 30 efficiently. As shown in FIG. 7, in order to provide the delay time table group 30, the delay time table 31, 32, 33 and 34 are created for respective of the timing arcs P11, P12, P21 and P22.

First, the timing arc P11 is selected as a representative timing arc. Then, the delay times with respect to all conditions of the fundamental condition group are obtained by using the fundamental condition table 35 shown in FIG. 5. Based on the obtained delay times, the degeneration process of the conditions is carried out. As a result, a condition group (referred to as a “first degenerate condition group” hereinafter) is extracted which indicates combinations of the first conditions A1 to A5 and the second conditions B1 to B5. Thus, the delay time table 31 indicating the delay times with respect to the first degenerate condition group is created (see FIG. 4). The created delay time table 31 is added to the delay time table group 30.

Next, the timing arc P22 is selected as a representative timing arc. Then, the delay times with respect to all conditions of the fundamental condition group are obtained by using the fundamental condition table 35 shown in FIG. 5. Based on the obtained delay times, the degeneration process of the conditions is carried out. As a result, a condition group (referred to as a “second degenerate condition group” hereinafter) is extracted which indicates combinations of the first conditions C1 to C6 and the second conditions D1 to D6. Thus, the delay time table 34 indicating the delay times with respect to the second degenerate condition group is created. The created delay time table 34 is added to the delay time table group 30.

Next, the delay time table 32 associated with the timing arc P12 is created. In this case, the fundamental condition table 35 is not used. As for the timing arc P12, the delay times are obtained on the basis of the above-mentioned first and second degenerate condition groups. More specifically, as for the timing arc P12, the delay times are determined for combinations (30 kinds) of the first conditions A1 to A5 constituting the first degenerate condition group and the second conditions D1 to D6 constituting the second degenerate condition group. Thus, the delay time table 32 indicating the delay times with respect to the 30 kinds of conditions is created. The created delay time table 32 is added to the delay time table group 30. In this way, the number of simulations is greatly reduced. Moreover, the degeneration process is not necessary in creating the delay time table 32. Therefore, the time required for creating the timing constraint library 10 is reduced.

Similarly, the delay time table 33 associated with the timing arc P21 is created. In this case, the fundamental condition table 35 is not used. As for the timing arc P21, the delay times are obtained on the basis of the above-mentioned first and second degenerate condition groups. More specifically, as for the timing arc P21, the delay times are determined for combinations (30 kinds) of the first conditions C1 to C6 constituting the second degenerate condition group and the second conditions B1 to B5 constituting the first degenerate condition group. Thus, the delay time table 33 indicating the delay times with respect to the 30 kinds of conditions is created. The created delay time table 33 is added to the delay time table group 30. In this way, the number of simulations is greatly reduced. Moreover, the degeneration process is not necessary in creating the delay time table 33. Therefore, the time required for creating the timing constraint library 10 is reduced.

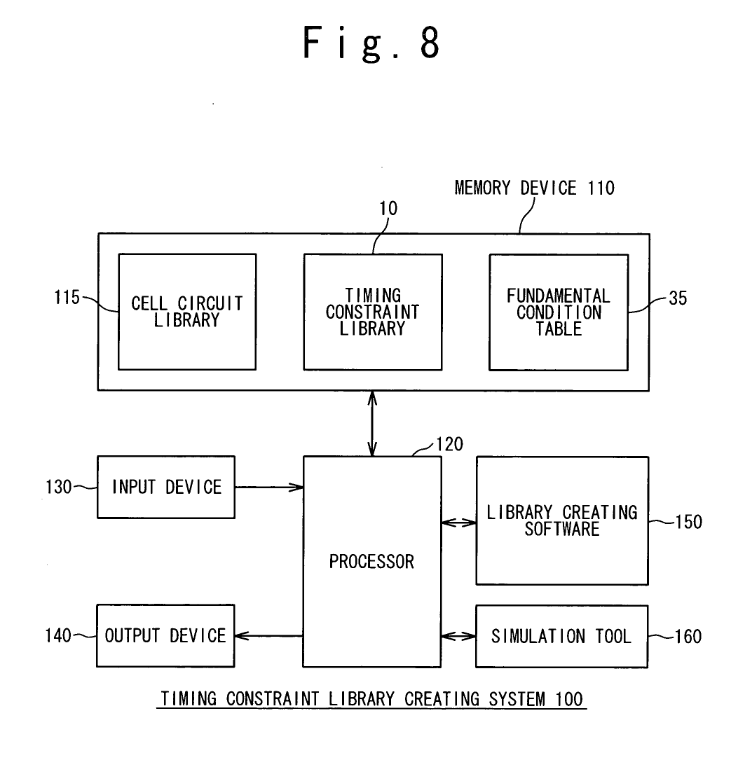

An example of a system for achieving the above-mentioned method of creating the timing constraint library 10 is shown in FIG. 8. FIG. 8 is a block diagram showing a configuration of a timing constraint library creating system 100. The timing constraint library creating system 100 according to the present embodiment includes a memory device 110, a processor 120, an input device 130, an output device 140, a library creating software 150, and a simulation tool 160. The timing constraint library creating system 100 is established on a work station, for example.

The processor 120 is configured to access the above-mentioned devices, and controls an operation of the timing constraint library creating system 100 by performing various processing.

The library creating software 150 is a software program executed by the processor 120. The library creating software 150 gives instructions to the processor 120, and makes the processor 120 carry out the selection of a timing arc P_{MN} and the degeneration process. In other words, the processor 120 operates according to the instructions by the library creating software 150 to carry out the above-mentioned method. Also, the simulation tool 160 is a software program executed by the processor 120, and executes a simulation of the cell operation under a given condition. The library creating software 150 or a user can calculate the “timing constraint” such as the delay time and the like by using the simulation tool 160.

The memory device 110 is connected to the processor 120, and stores the fundamental condition table 35 (see FIG. 5) and a cell circuit library. The cell circuit library 115 provides cell circuit data such as a layout data of the cell. The cell circuit data is referred to by the simulation tool 160 at the time of the simulation. Moreover, the timing constraint library 10 (see FIG. 1) produced by the timing constraint library creating system 100 is stored in the memory device 110. Furthermore, the above-mentioned library creating software 150 and the simulation tool 160 can be stored in the memory device 110. In addition, the foregoing first degenerate condition group and the second degenerate condition group may be stored in the memory device 110.

The input device 130 is connected with the processor 120. The input device 130 includes a keyboard and a mouse. By using the input device 130, a user can give predetermined commands and data to the timing constraint library creating system 100. The commands and the data input from the input device 130 are processed by the processor 120. Also, the output device 140 is connected with the processor 120. The output device 130 includes a display and a speaker. The user can give a new instruction based on information output from the output device 140.

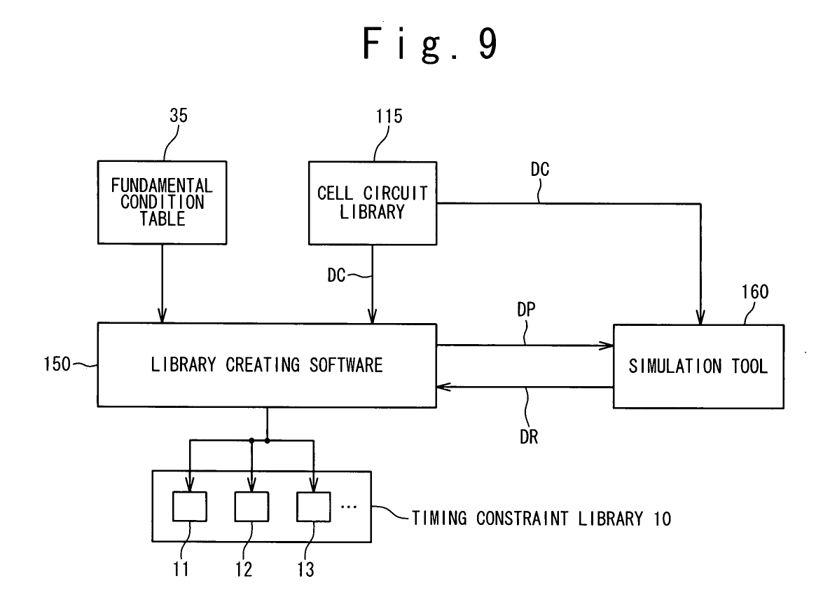

FIG. 9 is a block diagram showing an operation of the timing constraint library creating system 100. First, the library creating software 150 (processor 120) reads the fundamental condition table 35 stored in the memory device 110. Also, the library creating software 150 reads out a cell circuit data DC from the cell circuit library 115 stored in the memory device 110. The cell circuit data DC includes a layout data of a target cell (see FIG. 2).

Next, the library creating software 150 selects a representative pin and a representative timing arc by referring to the read cell circuit data DC. Here, the library creating software 150 may select a timing arc having minimum stages of transistors as the representative timing arc from the plurality of timing arcs P_{MN}.

Next, the library creating software 150 outputs to the simulation tool 160 a path-and-condition data DP which indicates the selected timing arc and condition group. In the case of the foregoing example, the path-and-condition data DP indicates the representative timing arc P11 and all conditions of the fundamental condition group given by the fundamental condition table 35. The simulation tool 160 receives the path-and-condition data DP from the library creating software 150 and the cell circuit data DC from the cell circuit library 115. Then, the simulation tool 160 (processor 120) simulates the representative timing arc P11 of the target cell under the all conditions by referring to the cell circuit data DC. Accordingly, the simulation tool 160 calculates the delay times (timing constraints) with respect to the representative timing arc P11 for all the conditions in the fundamental condition group. An analysis result data DR indicating a result of the simulation is returned back to the library creating software 150.

Next, the library creating software 150 carries out the “degeneration process” of the conditions based on the analysis result data DR. Thus, the optimum partial conditions (first degenerate condition group) are extracted from the fundamental condition group. The partial conditions are constituted by the combinations of the first conditions A1 to A5 and the second conditions B1 to B5 (see FIG. 7). The library creating software 150 creates the delay time table 31 indicating the delay times with respect to the partial conditions, and adds the created delay time table 31 to the timing constraint library 10 in the memory device 110. Also, the library creating software 150 may store the degenerate condition group, which is the partial conditions, in the memory device 110.

Next, the library creating software 150 selects a timing arc other than the representative timing arc from the plurality of timing arcs P_{MN}. If the selected timing arc shares the input pin or the output pin with the representative timing arc P11, namely, if the already-known degenerate condition group can be utilized, the library creating software 150 reads out the degenerate condition group from the memory device 110. Here, the library creating software 150 may obtain information about the degenerate condition group by referring to the delay time table 31 stored in the memory device 110. The degenerate condition group is a part of the fundamental condition group, and the number of conditions constituting the degenerate condition group is less than 225. The library creating software 150 outputs to the simulation tool 160 a path-and-condition data DP indicating the selected timing arc and the partial conditions. The simulation tool 160 simulates the selected timing arc P11 of the target cell under the partial conditions. Accordingly, the simulation tool 160 calculates the delay times (timing constraints) with respect to the selected timing arc for the partial conditions. An analysis result data DR indicating a result of the simulation is returned back to the library creating software 150.

The library creating software 150 creates a delay time table with respect to the selected timing arc based on the analysis result data DR, and adds the created delay time table to the timing constraint library 10 in the memory device 110. The library creating software 150 repeats the similar process for all of the timing arcs. As a result, the delay time table group 30 including the plurality of delay time tables 32, 33 and 34 is produced (refer to FIG. 7). The produced delay time table group 30 is a part of the timing constraint library 10 and is stored in the memory device 110.

Also, the example shown in FIG. 7 is now used to explain an operation of the timing constraint library creating system 100 according to the present invention. The processor 120 carries out the following operations in accordance with the instructions of library creating software 150 and the simulation tool 160. First, the processor 120 reads the fundamental condition table 35 and the cell circuit data DC from the memory device 110.

Next, the processor 120 selects the timing arc P11 as the representative timing arc by referring to the read cell circuit data DC. Then, the processor 120 executes the simulation with respect to all the conditions in the fundamental condition group given by the fundamental condition table 35, and thereby calculates the delay times with respect to the all conditions. Based on the simulation results, the processor 120 carries out the “degeneration process” to extract the first degenerate condition group which is composed of the combinations of the first conditions A1 to A5 and the second conditions B1 to B5 from the fundamental condition group. Then, the processor 120 creates the delay time table 31 indicating the delay times with respect to the first degenerate condition group and stores the created delay time table 31 in the memory device 110. Also, the processor 120 may store the extracted first degenerate condition group in the memory device 110.

Next, the processor 120 selects the timing arc P22 as the representative timing arc by referring to the read cell circuit data DC. Then, the processor 120 executes the simulation with respect to all the conditions in the fundamental condition group given by the fundamental condition table 35, and thereby calculates the delay times with respect to the all conditions. Based on the simulation results, the processor 120 carries out the “degeneration process” to extract the second degenerate condition group which is composed of the combinations of the first conditions C1 to C6 and the second conditions D1 to D6 from the fundamental condition group. Then, the processor 120 creates the delay time table 34 indicating the delay times with respect to the second degenerate condition group and stores the created delay time table 34 in the memory device 110. Also, the processor 120 may store the extracted second degenerate condition group in the memory device 110.

Next, the delay time table 32 with respect to the timing arc P12 is created. In this case, the fundamental condition table 35 is not used. As for the timing arc P12, the delay times are obtained by using the foregoing first degenerate condition group and the second degenerate condition group. More specifically, the processor 120 obtains information about the first and second degenerate condition groups by reading out the already-prepared delay time table 31 and the delay time table 34 from the memory device 110. Or, the processor 120 may read the first degenerate condition group and the second degenerate condition group directly stored in the memory device 110. Then, as for the timing arc P12, the processor 120 executes the simulation with respect to thirty combinations of the first conditions A1 to A5 constituting the first degenerate condition group and the second conditions D1 to D6 constituting the second degenerate condition group. Thus, the delay times with respect to the thirty conditions are calculated. Then, the processor 120 creates the delay time table 32 indicating the delay times for the thirty conditions and stores the created delay time table 32 in the memory device 110.

Similarly, the delay time table 33 with respect to the timing arc P21 is created. In this case, the fundamental condition table 35 is not used. As for the timing arc P21, the delay times are obtained by using the foregoing first degenerate condition group and the second degenerate condition group. More specifically, the processor 120 obtains information about the first and second degenerate condition groups by reading out the already-prepared delay time table 31 and the delay time table 34 from the memory device 110. Or, the processor 120 may read the first degenerate condition group and the second degenerate condition group directly stored in the memory device 110. Then, as for the timing arc P21, the processor 120 executes the simulation with respect to thirty combinations of the first conditions C1 to C6 constituting the second degenerate condition group and the second conditions B1 to B5 constituting the first degenerate condition group. Thus, the delay times with respect to the thirty conditions are calculated. Then, the processor 120 creates the delay time table 33 indicating the delay times for the thirty conditions and stores the created delay time table 33 in the memory device 110.

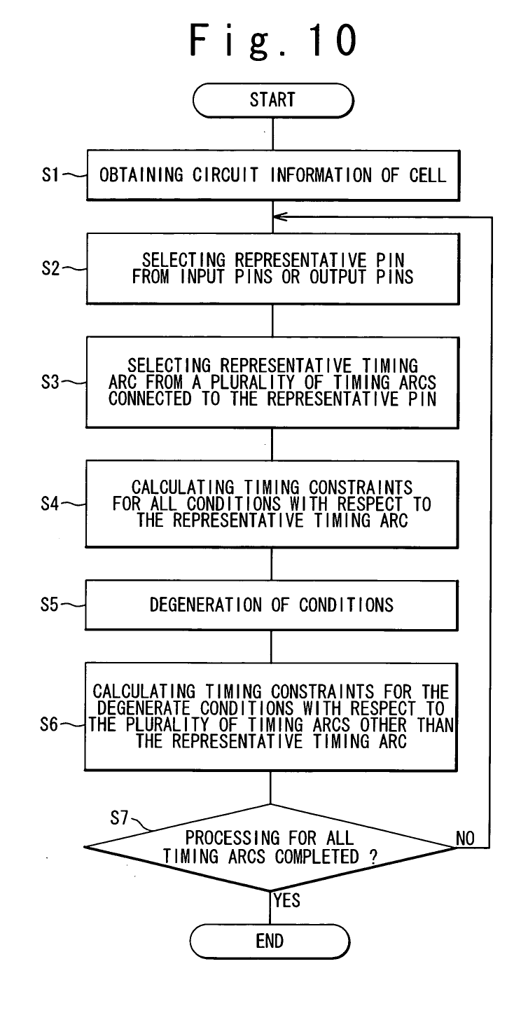

FIG. 10 is a flowchart which summarizes the method of creating the timing constraint library 10 according to present embodiment. First, the cell circuit library 115 is provided, and the cell circuit data DC is obtained (Step S1). Next, one representative pin is selected from the plurality of input pins In or the plurality of output pins Out (Step S2). Next, one representative timing arc is selected from the plurality of timing arcs P_{MN} connected to the representative pin (Step S3). Next, with regard to the representative timing arc, the timing constraints (delay times) are calculated for all conditions of the fundamental condition group provided by the fundamental condition table 35 (Step S4). Next, on the basis of the result of the Step S3, the degeneration process of the conditions is carried out (Step S5). Next, with regard to another timing arc different from the representative timing arc, the timing constraints are calculated for the known degenerate conditions (Step S6). If there remains a timing arc which is not considered yet (Step S7; No), the foregoing Steps S2 to S6 are repeated. When the processing for all of the timing arcs P_{MN} is completed (Step S7; Yes), the constraint table group (delay time table group 30) is generated.

According to the method and the system for creating the timing constraint library 10 in the present invention, as described above, the delay times are calculated for only a part of the fundamental condition group with respect to the timing arc other than the representative timing arc. Therefore, the number of simulations is decreased, and hence the time required for creating the delay time tables 32, 33 is reduced. As a result, the time for creating the timing constraint library 10 is reduced.

### Second Embodiment

In a second embodiment of the present invention, the “timing constraint” is the output waveform rounding (output slope) which indicates a degree of rounding of a signal at the output pin Out. The output waveform rounding table group 40 shown in FIG. 3 includes a plurality of output waveform rounding tables (timing constraint tables). The plurality of output waveform rounding tables are created for respective of the plurality of timing arcs P_{MN}.

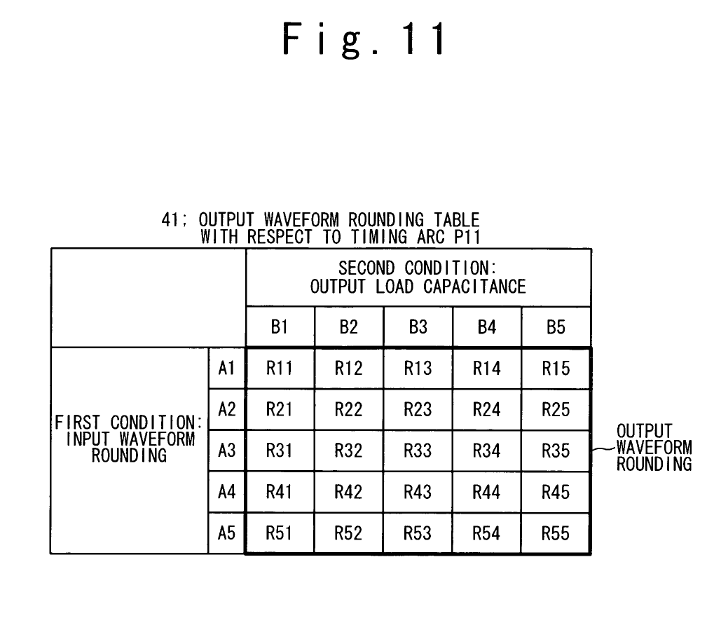

FIG. 11 is a conceptual diagram showing contents of an output waveform rounding table 41 which is created with respect to the timing arc P11. The output waveform rounding table 41 is a two-dimensional array indicating the output waveform roundings with respect to a plurality of conditions. The plurality of conditions are given by combinations of a plurality of first conditions and a plurality of second conditions. In the present embodiment, the first condition (first table index) is an “input waveform rounding (input slope)” which is a degree of waveform rounding of a signal input to the input pin In, and the second condition (second table index) is an “output load capacitance” which is a load capacitance applied to the output pin Out. For example, the plurality of conditions are given by combinations of the first conditions A1 to A5 and the second conditions B1 to B5 in FIG. 11. The output waveform rounding table 41 represents 25 kinds of output waveform roundings R11 to R55 for respective combinations.

A method of creating the output waveform rounding table group 40 including such the output waveform rounding table 41 is similar to the method described in the first embodiment (refer to FIGS. 7 and 10). Also, a configuration and an operation of a system for creating the output waveform rounding table group 40 are similar to those of the system 100 described in the first embodiment (refer to FIGS. 8 and 9). With regard to the representative timing arc, the output waveform roundings are calculated with respect to all the conditions of the fundamental condition group by using the fundamental condition table 35. On the other hand, with regard to the timing arcs other than the representative timing arc, the output waveform roundings are calculated with respect to the degenerate conditions (partial conditions). Therefore, the number of simulations is decreased, and hence the time required for creating the output waveform rounding tables associated with the timing arcs other than the representative timing arc is reduced. As a result, the time for creating the timing constraint library 10 is reduced.

### Third Embodiment

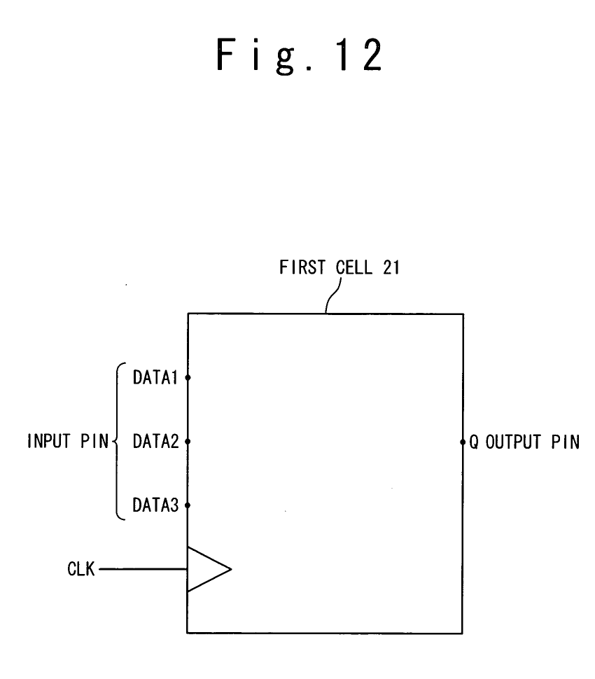

FIG. 12 is a schematic diagram showing a configuration of a cell according to the third embodiment of the present invention. In FIG. 12, a configuration of a first cell 21 is shown as an example. The first cell 21 is a sequential circuit such as a flip-flop and has a plurality of input pins (DATA1 to DATA3), a clock pin and an output pin Q. An input signals DATA is input to any of the input pins DATA1 to DATA3. A clock signal CLK is input to the clock pin.

In the present embodiment, the timing constraint is a “setup time” of the input signal DATA with respect to the clock signal CLK. The setup time table group 50 shown in FIG. 3 includes a plurality of setup time tables (timing constraint tables). The plurality of setup time tables are created for respective of the plurality of input pins DATA1 to DATA3.

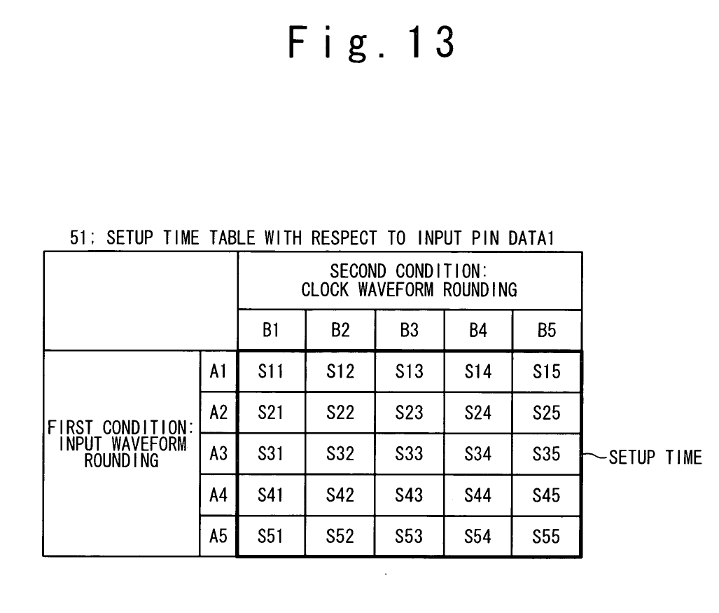

FIG. 13 is a conceptual diagram showing contents of a setup time table 51 which is created with respect to the input pin DATA1. The setup time table 51 is a two-dimensional array indicating the setup times with respect to a plurality of conditions. The plurality of conditions are given by combinations of a plurality of first conditions and a plurality of second conditions. In the present embodiment, the first condition (first table index) is an “input waveform rounding (input slope)” which is a degree of waveform rounding of the input signal input to the input pin DATA1, and the second condition (second table index) is a “clock waveform rounding” which is a degree of waveform rounding of the clock signal. For example, the plurality of conditions are given by combinations of the first conditions A1 to A5 and the second conditions B1 to B5 in FIG. 13. The setup time table 51 represents 25 kinds of setup times S11 to S55 for respective combinations.

A configuration of a system for creating the setup time table group 50 is similar to the configuration of the system 100 shown in FIG. 8. First, the library creating software 150 (processor 120) reads the fundamental condition table 35 (see FIG. 5) stored in the memory device 110. Also, the library creating software 150 reads out the cell circuit data DC from the cell circuit library 115 stored in the memory device 110. The cell circuit data DC includes a layout data of a target cell shown in FIG. 12.

Next, the library creating software 150 selects one the plurality of input pins DATA1 to DATA3 as a representative pin by referring to the read cell circuit data DC. For example, the input pin DATA1 is selected as the representative pin.

Next, the library creating software 150 outputs to the simulation tool 160 a path-and-condition data DP which indicates the selected input pin and a condition group. In this case, the path-and-condition data DP indicates the representative pin (input pin DATA1) and all conditions of the fundamental condition group given by the fundamental condition table 35. The simulation tool 160 receives the path-and-condition data DP from the library creating software 150 and the cell circuit data DC from the cell circuit library 115. Then, the simulation tool 160 (processor 120) simulates the target cell under the all conditions by referring to the cell circuit data DC. Accordingly, the simulation tool 160 calculates the setup times (timing constraints) for the representative pin with respect to all the conditions in the fundamental condition group. An analysis result data DR indicating a result of the simulation is returned back to the library creating software 150.

Next, the library creating software 150 carries out the “degeneration process” of the conditions based on the analysis result data DR. Thus, an optimum partial conditions (first degenerate condition group) are extracted from the fundamental condition group. For example, the partial conditions are constituted by combinations of the first conditions A1 to A5 and the second conditions B1 to B5 (refer to FIG. 13). The library creating software 150 creates the setup time table 51 indicating the setup times with respect to the partial conditions, and adds the created setup time table 51 to the timing constraint library 10 in the memory device 110. Also, the library creating software 150 may store the degenerate condition group, which is the partial conditions, in the memory device 110.

Next, the library creating software 150 selects an input pin other than the representative input pin from the plurality of input pins DATA1 to DATA3. Also, the library creating software 150 reads out the degenerate condition group from the memory device 110. Here, the library creating software 150 may obtain information about the degenerate condition group by referring to the setup time table 51 stored in the memory device 110. The library creating software 150 outputs to the simulation tool 160 a path-and-condition data DP indicating the selected input pin and the partial conditions. The simulation tool 160 simulates the target cell under the partial conditions. Accordingly, the simulation tool 160 calculates the setup times (timing constraints) for the selected input pin with respect to the partial conditions. An analysis result data DR indicating a result of the simulation is returned back to the library creating software 150.

The library creating software 150 creates a setup time table with respect to the selected input pin based on the analysis result data DR, and adds the created setup time table to the timing constraint library 10 in the memory device 110. The library creating software 150 repeats the similar process for all of the input pins DATA1 to DATA3. As a result, the setup time table group 50 including the plurality of setup time tables is produced. The produced setup time table group 50 is a part of the timing constraint library 10 and is stored in the memory device 110.

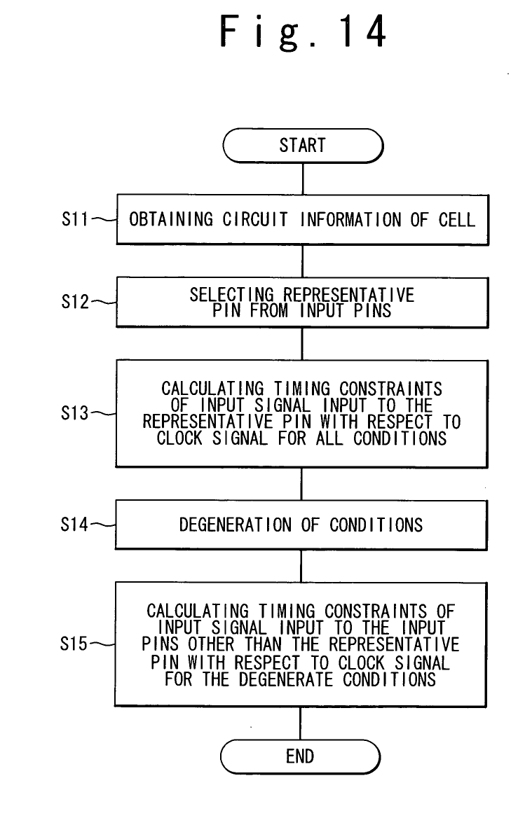

FIG. 14 is a flowchart which summarizes the method of creating the timing constraint library 10 according to present embodiment. First, the cell circuit library 115 is provided, and the cell circuit data DC is obtained (Step S11). Next, one representative pin is selected from the plurality of input pins DATA1 to DATA3 (Step S12). Next, the setup times of the input signal input to the representative pin with respect to the clock signal CLK are calculated for all the conditions of the fundamental condition group (Step S13). Next, the degeneration process of the conditions is carried out on the basis of the result of the Step S13, and the partial conditions (degenerate conditions) are extracted from the fundamental condition group (Step S14). Next, the setup times of the input signal input to each of the input pins other than the representative pin with respect to the clock signal CLK is calculated for the degenerate conditions (Step S15). The processes for all of the input pins DATA1 to DATA3 are completed, and the constraint table group (setup time table group 50) is created.

According to the method and the system for creating the timing constraint library 10 in the present invention, as described above, the setup times are calculated for only a part of the fundamental condition group with respect to the input pin other than the representative pin. Therefore, the number of simulations is decreased, and hence the time required for creating the setup time tables associated with the input pins other than the representative pin is reduced. As a result, the time for creating the timing constraint library 10 is reduced.

### Fourth Embodiment

In a fourth embodiment of the present invention, the timing constraint is a “hold time” of the input signal DATA with respect to the clock signal CLK. The hold time table group 60 shown in FIG. 3 includes a plurality of hold time tables (timing constraint tables). The plurality of hold time tables are created for respective of the plurality of input pins DATA1 to DATA3.

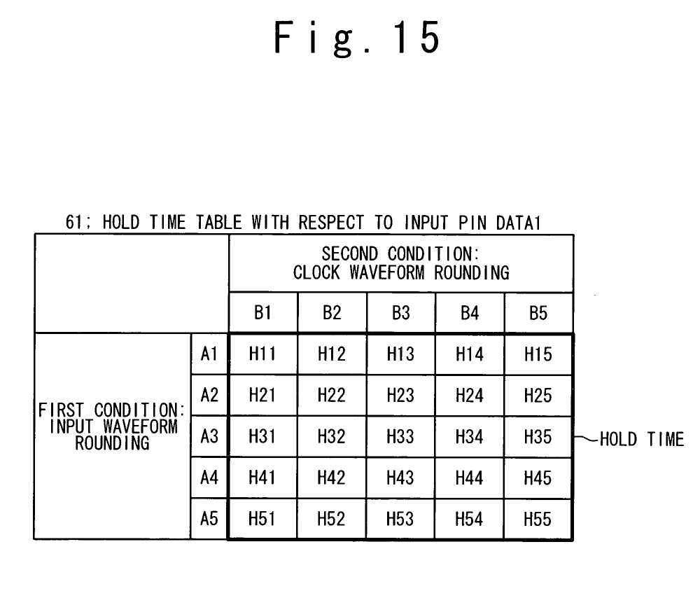

FIG. 15 is a conceptual diagram showing contents of a hold time table 61 which is created with respect to the input pin DATA1. The hold time table 61 is a two-dimensional array indicating the hold times with respect to a plurality of conditions. The plurality of conditions are given by combinations of a plurality of first conditions and a plurality of second conditions. In the present embodiment, the first condition (first table index) is an “input waveform rounding (input slope)” which is a degree of waveform rounding of the input signal input to the input pin DATA1, and the second condition (second table index) is a “clock waveform rounding” which is a degree of waveform rounding of the clock signal. For example, the plurality of conditions are given by combinations of the first conditions A1 to A5 and the second conditions B1 to B5 in FIG. 15. The hold time table 61 represents 25 kinds of hold times H11 to H55 for respective combinations.

A method of creating the hold time table group 60 including such the hold time table 61 is similar to the method described in the third embodiment (refer to FIG. 14). Also, a configuration and an operation of a system for creating the hold time table group 60 are similar to those described in the third embodiment. With regard to the representative pin, the hold times are calculated with respect to all the conditions of the fundamental condition group by using the fundamental condition table 35. On the other hand, with regard to the input pins other than the representative pin, the hold times are calculated with respect to the degenerate conditions (partial conditions). Therefore, the number of simulations is decreased, and hence the time required for creating the hold time tables associated with the input pins other than the representative pin is reduced. As a result, the time for creating the timing constraint library 10 is reduced.

It is apparent that the present invention is not limited to the above embodiment, and that may be modified and changed without departing from the scope and spirit of the invention.

What is claimed is:

1. A method of creating a timing constraint library which provides timing constraint of a cell,
said cell having at least one input pin and at least one output pin in which each of said at least one input pin is connected to each of said at least one output pin through a corresponding one of a plurality of timing arcs,
said method comprising:
(A) providing a memory device which stores circuit data of said cell;
(B) a processor selecting one of said plurality of timing arcs as a representative timing arc by referring to said circuit data stored in said memory device;
(C) said processor calculating said timing constraint with respect to said representative timing arc by simulating said cell under all conditions of a predetermined fundamental condition group;
(D) said processor extracting partial conditions from said predetermined fundamental condition group; and
(E) said processor calculating said timing constraint with respect to another of said plurality of timing arcs which shares any of said input pin and said output pin with said representative timing arc by simulating said cell under said extracted partial conditions.

2. The method according to claim 1,
wherein in said step (D) said processor extracts said partial conditions such that a function representing a relation between said all conditions and said timing constraint is approximated within a predetermined error range by a function representing a relation between said partial conditions and said timing constraint.

3. The method according to claim 1,
wherein in said step (B) a timing arc having minimum stages of transistors is selected as said representative timing arc out of said plurality of timing arcs.

4. The method according to claim 1,
wherein said timing constraint is a delay time from said input pin to said output pin, and
said predetermined fundamental condition group indicates combinations of waveform roundings of a signal input to said input pin and load capacitances applied to said output pin.

5. The method according to claim 1,
wherein said timing constraint is a waveform rounding of a signal at said output pin, and
said predetermined fundamental condition group indicates combinations of waveform roundings of a signal input to said input pin and load capacitances applied to said output pin.

6. A method of creating a timing constraint library which provides timing constraint of a cell,
said cell having M input pins (M is a natural number) and N output pins (N is a natural number) in which timing arcs connecting between said M input pins and said N output pins are denoted by an MN matrix P_{MN},
said method comprising:
(AA) a processor calculating said timing constraint with respect to a timing arc Pᵢᵢ (i is a natural number not less than 1 and not more than M and N) by simulating said cell under all conditions of a predetermined fundamental condition group;
(BB) said processor generating a first degenerate condition group by degenerating said predetermined fundamental condition group based on a result of said step (AA), and storing said generated first degenerate condition group in a memory device;
(CC) said processor calculating said timing constraint with respect to another timing arc Pⱼⱼ (j is a natural number not less than 1 and not more than M and N) by simulating said cell under all conditions of said predetermined fundamental condition group;
(DD) said processor generating a second degenerate condition group by degenerating said predetermined fundamental condition group based on a result of said step (CC), and storing said generated second degenerate condition group in said memory device; and
(EE) said processor calculating said timing constraint with respect to timing arcs Pᵢⱼ and Pⱼᵢ by simulating said cell under said first degenerate condition group and said second degenerate condition group stored in said memory device.

7. The method according to claim 6,
wherein said predetermined fundamental condition group indicates combinations of first conditions and second conditions,
said step (EE) comprises:
(E1) said processor calculating said timing constraint with respect to said timing arc Pᵢⱼ for combinations of said first conditions constituting said first degenerate condition group and said second conditions constituting said second degenerate condition group; and
(E2) said processor calculating said timing constraint with respect to said timing arc Pⱼᵢ for combinations of said first conditions constituting said second degenerate condition group and said second conditions constituting said first degenerate condition group.

8. The method according to claim 7,
wherein said first conditions are waveform roundings of a signal input to corresponding one of said M input pins,
said second conditions are load capacitances applied to corresponding one of said N output pins, and
said timing constraint is a delay time from said corresponding one input pin to said corresponding one output pin.

9. The method according to claim 7,
wherein said first conditions are waveform roundings of a signal input to corresponding one of said M input pins,
said second conditions are load capacitances applied to corresponding one of said N output pins, and
said timing constraint is a waveform rounding of a signal at said corresponding one output pin.

10. A method of creating a timing constraint library which provides timing constraint of a cell,
said cell having a plurality of input pins and a clock pin to which a clock signal is input,
said method comprising:
(a) providing a memory device which stores circuit data of said cell;
(b) a processor selecting one of said plurality of input pins as a representative pin by referring to said circuit data stored in said memory device;
(c) said processor calculating said timing constraint of an input signal input to said representative pin with respect to said clock signal by simulating said cell under all conditions of a predetermined fundamental condition group;
(d) said processor extracting partial conditions from said predetermined fundamental condition group; and
(e) said processor calculating said timing constraint of an input signal input to another of said plurality of input pins with respect to said clock signal by simulating said cell under said extracted partial conditions.

11. The method according to claim 10,
wherein in said step (d) said processor extracts said partial conditions such that a function representing a relation between said all conditions and said timing constraint is approximated within a predetermined error range by a function representing a relation between said partial conditions and said timing constraint.

12. The method according to claim 10,
wherein said timing constraint is any of a setup time and a hold time of said input signal with respect to said clock signal, and
said predetermined fundamental condition group indicates combinations of waveform roundings of said input signal and waveform roundings of said clock signal.

13. A system for creating a timing constraint library which provides timing constraint of a cell, comprising:
a memory device configured to store circuit data of said cell, said cell having at least one input pin and at least one output pin in which each of said at least one input pin is connected to each of said at least one output pin through a corresponding one of a plurality of timing arcs;
a processor configured to access said memory device; and
software executed by said processor,
wherein said processor operates according to instructions by said software to
read out said circuit data from said memory device,
select one of said plurality of timing arcs as a representative timing arc by referring to said circuit data,
calculate said timing constraint with respect to said representative timing arc by simulating said cell under all conditions of a predetermined fundamental condition group,
extract partial conditions from said predetermined fundamental condition group, and
calculate said timing constraint with respect to another of said plurality of timing arcs which shares any of said input pin and said output pin with said representative timing arc by simulating said cell under said extracted partial conditions.

14. The system according to claim 13,
wherein said processor extracts said partial conditions such that a function representing a relation between said all conditions and said timing constraint is approximated within a predetermined error range by a function representing a relation between said partial conditions and said timing constraint.

15. The system according to claim 13,
wherein a timing arc having minimum stages of transistors is selected as said representative timing arc out of said plurality of timing arcs.

16. The system according to claim 13,
wherein said timing constraint is a delay time from said input pin to said output pin, and
said predetermined fundamental condition group indicates combinations of waveform roundings of a signal input to said input pin and load capacitances applied to said output pin.

17. The system according to claim 13,
wherein said timing constraint is a waveform rounding of a signal at said output pin, and
said predetermined fundamental condition group indicates combinations of waveform roundings of a signal input to said input pin and load capacitances applied to said output pin.

18. A system for creating a timing constraint library which provides timing constraint of a cell, comprising:
a memory device configured to store circuit data of said cell, said cell having a plurality of input pins and a clock pin to which a clock signal is input;
a processor configured to access said memory device; and
software executed by said processor,
wherein said processor operates according to instructions by said software to read out said circuit data from said memory device,
select one of said plurality of input pins as a representative pin by referring to said circuit data,
calculate said timing constraint of an input signal input to said representative pin with respect to said clock signal by simulating said cell under all conditions of a predetermined fundamental condition group,
extract partial conditions from said predetermined fundamental condition group, and
calculate said timing constraint of an input signal input to another of said plurality of input pins with respect to said clock signal by simulating said cell under said extracted partial conditions.

19. The system according to claim 18,
wherein said processor extracts said partial conditions such that a function representing a relation between said all conditions and said timing constraint is approximated within a predetermined error range by a function representing a relation between said partial conditions and said timing constraint.

20. The system according to claim 18,
wherein said timing constraint is any of a setup time and a hold time of said input signal with respect to said clock signal, and
said predetermined fundamental condition group indicates combinations of waveform roundings of said input signal and waveform roundings of said clock signal.
